(19) United States
(12) Patent Application Publication
(10) Pub. No.: US 2010/0308951 A1
(43) Pub. Date: Dec. 9, 2010

(54) PROCEDURE FOR MANUFACTURING A MAGNETIC CORE AND A MAGNETIC CORE

(76) Inventor: Jarkko Salomäki, Tuusula (FI)

Correspondence Address: BIRCH STEWART KOLASCH & BIRCH, PO BOX 747, FALLS CHURCH, VA, 22040-0747, US

(21) Appl. No.: 12/739,680

(22) PCT Filed: Oct. 24, 2008
(86) PCT No.: PCT/FI2008/050597

§ 371 Date: Jun. 21, 2010

(30) Foreign Application Priority Data
Oct. 24, 2007 (FI) 20070798

(51) Int. Cl. H01F 27/24; B22F 3/02; H01F 41/02

(52) U.S. Cl. 336/233; 419/66

(57) ABSTRACT

This invention relates to the manufacture of inductive components and electric energy filters. Particularly, this invention relates to the manufacture of a large magnetic core piece. The magnetic core consists of at least one set of essentially identical constituents (1) compressed out of a powdery material. The constituents are assembled in such a way that they prevent each other from moving in at least one direction.

The objects of this invention are a procedure for manufacturing a magnetic core specified in the preamble of claim 1, and a magnetic core specified in the preamble of claim 7.

This invention relates to the manufacture of inductive components and electric energy filters. Particularly, this invention relates to the manufacture of a large magnetic core piece. Inductive components, such as chokes and transformers, are used for the storage of energy (chokes) and for the transmission of energy over a galvanic isolation (transformers) using a magnetic field. Inductive components comprise a coil and a core, of which there may be one or more, and which are in direct contact with one another. Voltage applied to the coil produces in the core a changing magnetic field, which is capable of storing energy. This voltage applied to the coil induces a voltage to the coil itself (self induction) and to other, so-called secondary coils that may be connected to the same core piece, in which case energy can be transferred from the primary coil to the secondary coils. Transformer iron plates, iron powder, ferrite and amorphous metals, among others, are used as the core material in inductive components. Copper wire, aluminum wire, circuit board, foils, among others, are used as the coil for inductive components. In addition, inductive components can be integrated with other kinds of components, such as resistors and capacitors as well as switching components to achieve e.g. filters.

Nowadays inductive components and filters are designed and manufactured individually for each application object and current value. For example, when transformers and chokes are made of laminated iron, each component size must have a stamped core sheet designed particularly for that size, i.e. a stamped core sheet of the same individual size. Thus to manufacture, for example, a 1-1000 A filter family, a significant amount of various core sheets are needed, in which case it is complicated to arrange the production logistics because there are a lot of various items in production. Thus it is difficult to manage at the same time the CONFIRMATION COPY production process of inductive components that have small and medium as well as big current value, i.e. of small, medium and large inductive components.

When intending to make the manufacturing of magnetic cores more effective, particularly interesting are magnetic cores manufactured out of a magnetic powder by pressing and sintering processes i.e. by powder metallurgy; these cores are mechanically strong and geometric details can be effectively joined to them. This kind of a powder core may be practically arbitrary in shape, depending on the mold that is used. Usually, however, only one-dimensional, e.g. vertical compression is used, when the mold presses the powder down from the upside and up from the underside, thus the forming magnetic core can be removed from the mold simply by pushing it with the other half of the mold. The size of magnetic cores manufactured by means of powder compression is limited to the pressing apparatus's maximum pressing area, which is determined according to the maximum pressure output of the pressing apparatus. Typically, the pressure can be, for example, 500 tons, and the largest pressing apparatuses may have a pressure of, for example, 1000 tons.

Small and medium magnetic cores are manufactured out of a powder by pressing, but this process is not suitable for manufacturing the largest cores, e.g. choke cores required for a 1000A current.

It can be generally stated that known powder core manufacturing methods limit the size of the magnetic core that can be achieved.

The purpose of the invention being presented here is to improve the manufacture and performance of inductive component cores and to achieve an advantageous and reliable magnetic core. The purpose is also to achieve a magnetic core, in which the adverse effects of the eddy currents are as small as possible. The procedure according to the invention is characterized by what is disclosed in the characterization part of claim 1. Similarly, the magnetic core piece according to the invention is characterized by what is disclosed in the characterization part of claim 7. Other embodiments of the invention are characterized by what is disclosed in the other claims.

The procedure according to the invention can be applied to effectively and flexibly manufacture different types of magnetic core pieces and inductive components composed of them, utilizing effectively the available pressing capacity. Another advantage is that the adverse effects of the eddy currents in the core are extremely small. In addition, it is possible to make the production logistics simple and different types of additional features can easily be tailored into the components being manufactured. It is also easy to automate the manufacturing process according to the procedure.

In the primary embodiment the magnetic core is manufactured out of parts that are rectangular prisms in shape and have attachment elements. In the second embodiment the magnetic core is manufactured out of hexagonal parts that have attachment elements. In the third embodiment the magnetic core is manufactured out of e.g. cylindrical or rectangular parts that have no specific attachment elements.

The invention is described below in greater detail using various examples of embodiments, with reference made to the enclosed indicative drawings, wherein:

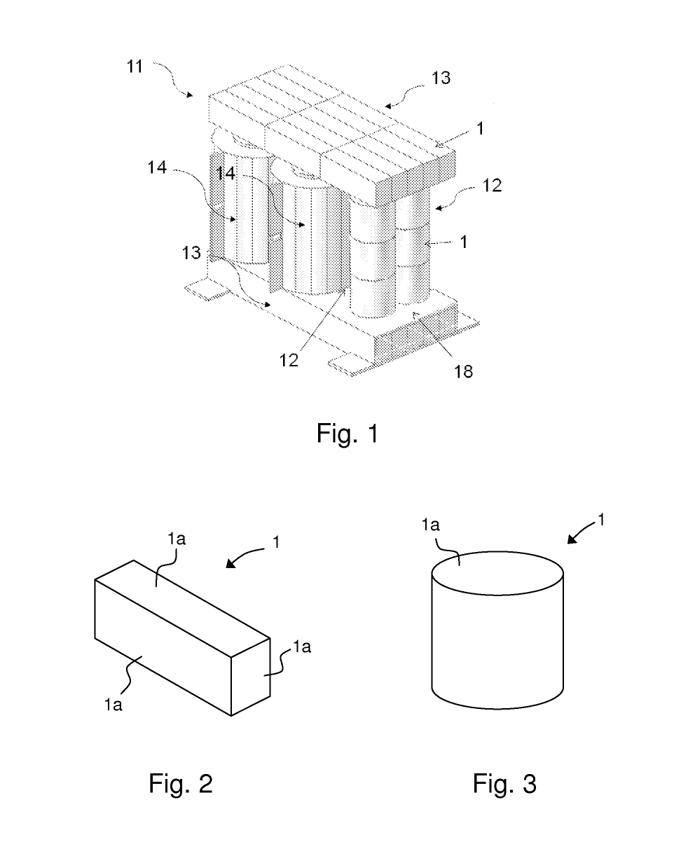

FIG. 1 presents a simplified and diagrammatic diagonal top view of a choke consisting at least of cylindrical assemblies, coils and assemblies that are composed of rectangular constituents,

FIG. 2 presents a diagonal top view of a magnetic core piece according to the invention,

FIG. 3 presents a diagonal top view of another magnetic core piece according to the invention,

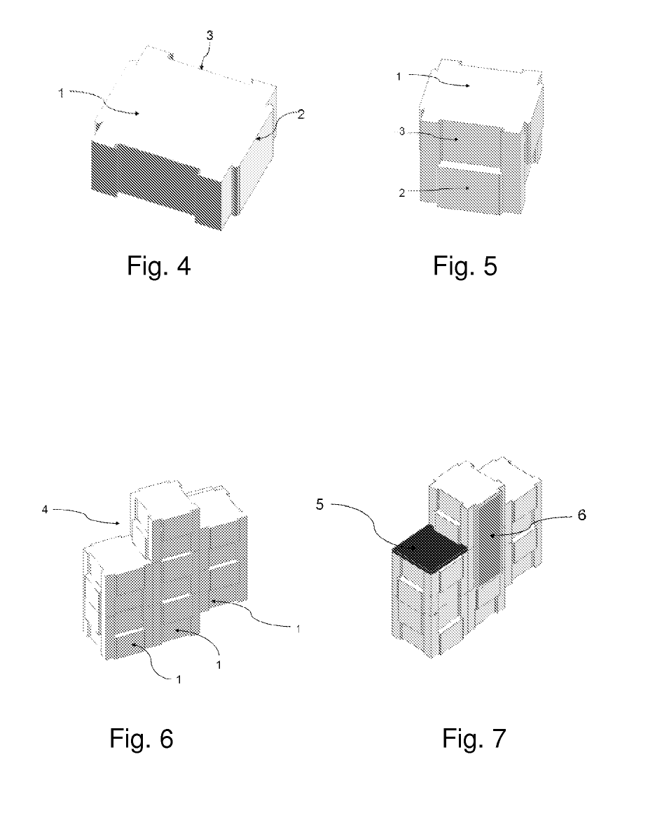

FIG. 4 presents a diagonal top view of a third magnetic core piece according to the invention,

FIG. 5 presents a diagonal top view of yet another magnetic core piece according to the invention,

FIG. 6 presents a diagonal top view of an assembly consisting of constituents according to the invention,

FIG. 7 presents a diagonal top view of another assembly consisting of constituents according to the invention,

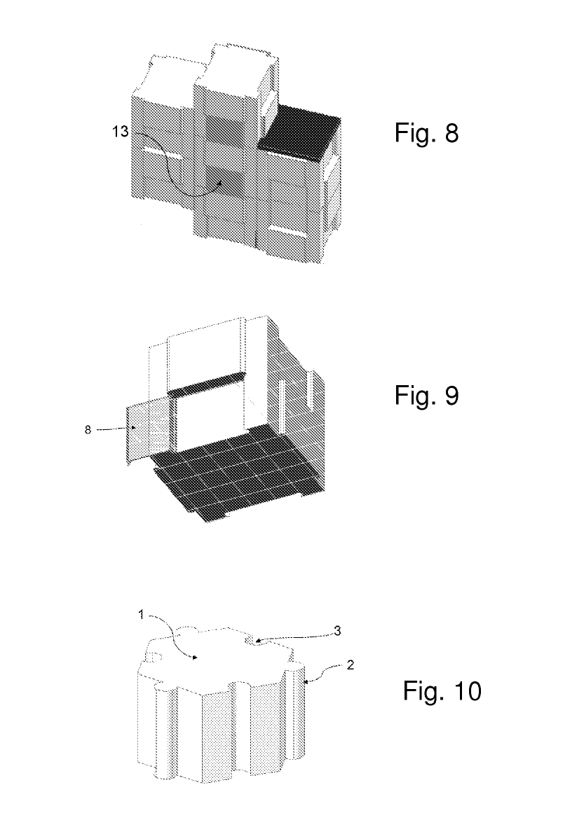

FIG. 8 presents a diagonal top view of a third assembly consisting of constituents according to the invention,

FIG. 9 presents a diagonal top view of a constituent according to the invention, with an attachment element placed in it,

FIG. 10 presents a diagonal top view of a hexagonal constituent according to the invention,

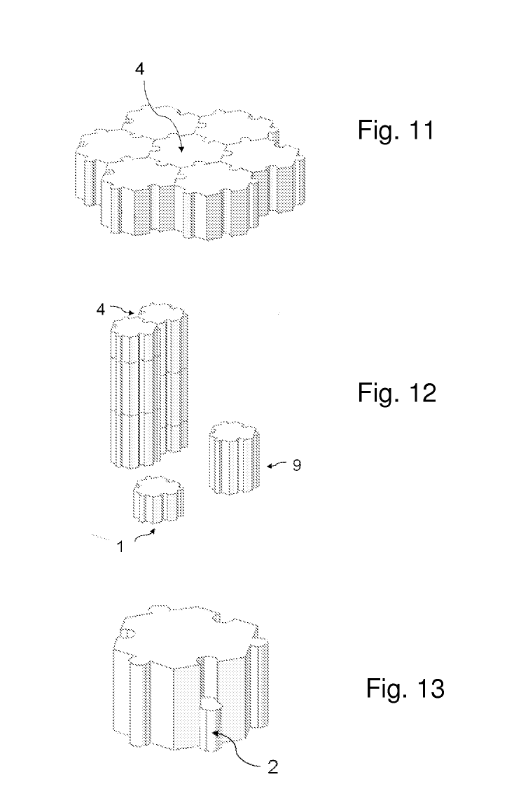

FIG. 11 presents a diagonal top view of an assembly consisting of hexagonal constituents,

FIG. 12 presents a diagonal top view of a flat and a tall constituent and continuous assembly consisting of them,

FIG. 13 presents a diagonal top view of a hexagonal constituent that has a cantilever in the same vertical line as a cavity,

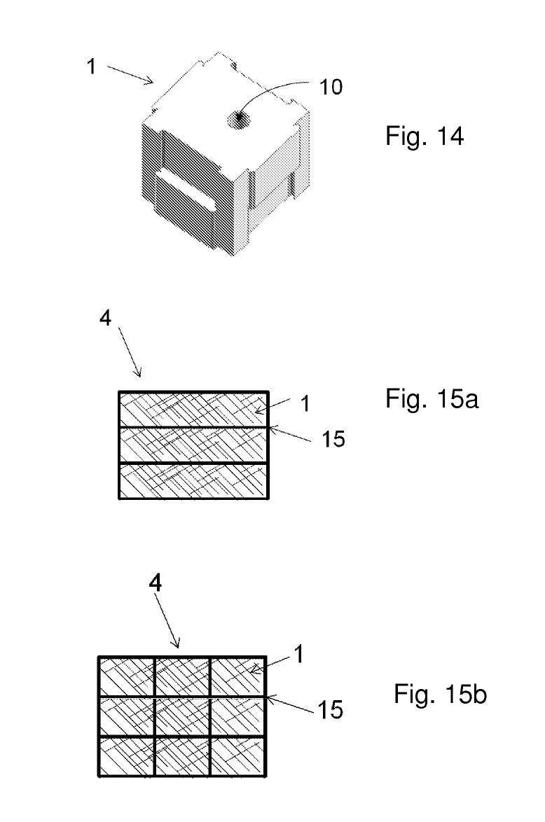

FIG. 14 presents a diagonal top view of a constituent that has a hole i.e. an attachment slot in it,

FIG. 15a presents a simplified and diagrammatic end view of a method to manufacture a magnetic core assembly,

FIG. 15b presents a simplified and diagrammatic end view of another method to manufacture a magnetic core assembly,

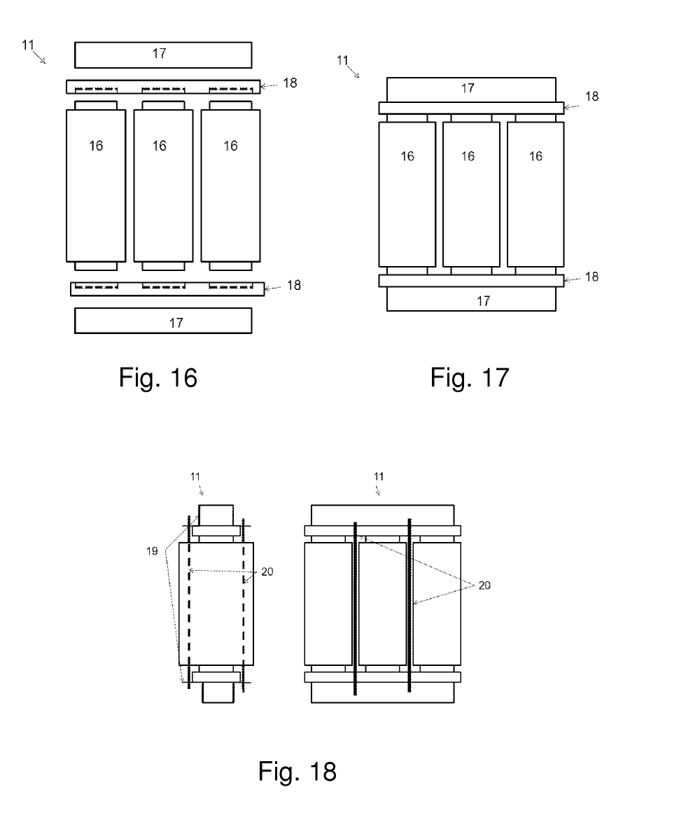

FIG. 16 presents a simplified and diagrammatic side view of the most important constituents of a choke according to the invention,

FIG. 17 presents a simplified and diagrammatic side view of a choke assembled of choke constituents according to the invention,

FIG. 18 presents a simplified and diagrammatic side and front view of a mechanical structure reinforcement of a choke according to the invention,

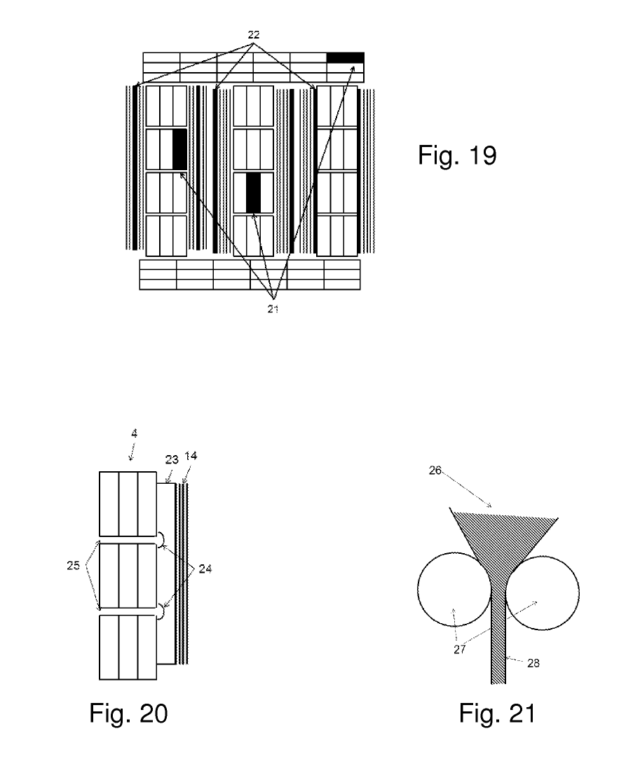

FIG. 19 presents a simplified and diagrammatic side view of an implementation of a liquid cooling of a choke according to the invention,

FIG. 20 presents a simplified and diagrammatic side view of a solution according to the invention for slotting a heat exchanger,

FIG. 21 presents a simplified and diagrammatic side view of a method to manufacture a core laminate according to the invention out of a metal powder,

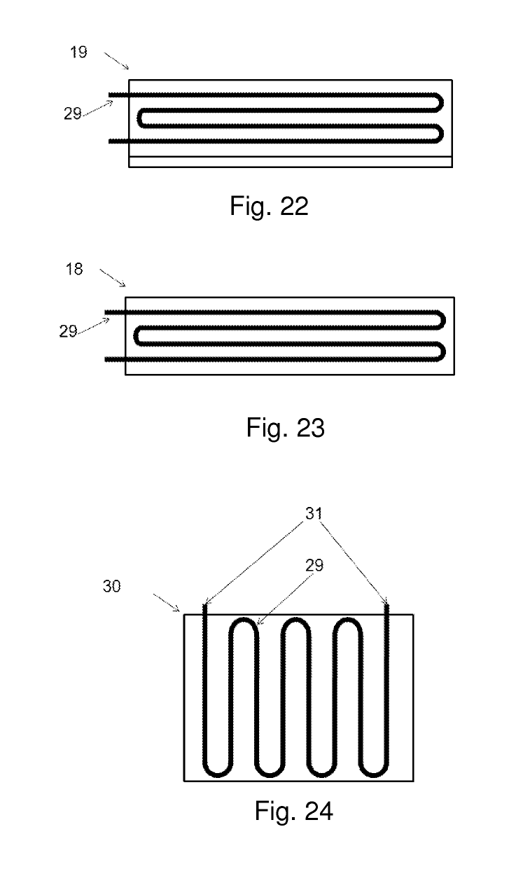

FIG. 22 presents a simplified and diagrammatic side view of a method to implement a liquid cooling in the channels of the horizontal bars of a choke,

FIG. 23 presents a simplified and diagrammatic top view of a method to implement a liquid cooling in the insulating pieces of a choke,

FIG. 24 presents a simplified and diagrammatic side view of a method to implement a liquid cooling in the winding of a core,

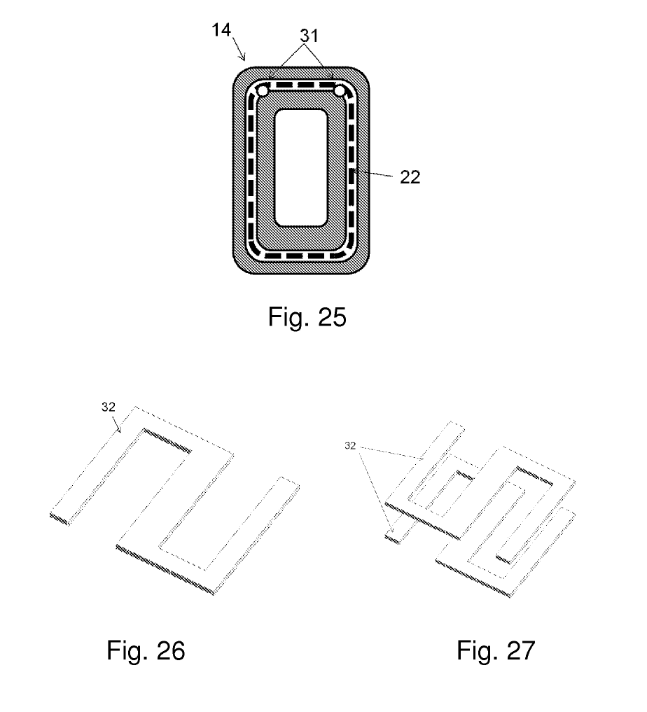

FIG. 25 presents a simplified and diagrammatic top view of a cooling construction manufactured according to FIG. 23,

FIG. 26 presents a simplified and diagrammatic diagonal top view of an initial manufacturing phase of a coil,

FIG. 27 presents a simplified and diagrammatic diagonal top view of a following manufacture phase of a coil according to FIG. 25,

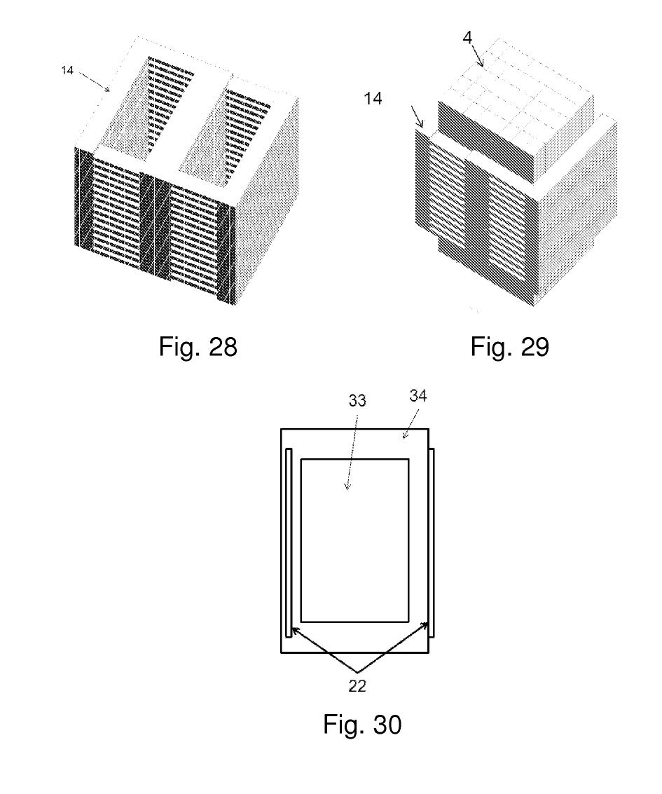

FIG. 28 presents a simplified and diagrammatic diagonal top view of a coil structure manufactured according to the method in FIGS. 25 and 26,

FIG. 29 presents a simplified and diagrammatic diagonal top view of a choke manufactured according to the method in FIGS. 25-27, and

FIG. 30 presents a simplified and diagrammatic top view of an alternative method to cool either the coil, several coils, capacitors or the whole choke or the filter.

FIG. 1 presents a choke 11 simplified and diagrammatically, which choke consists of cylindrical subassemblies 12 composed of cylindrical constituents 1, which subassemblies 12 in this case form the vertical poles of the core of the choke. The constituents 1 don't necessarily have any specific attachment elements. Cylindrical constituents 1 can be attached to each other by gluing or, for example, placing a thin tube around them. In addition, the magnetic circuit of the core is closed from the top and the bottom with rectangular subassemblies 13 composed of rectangular constituents 1, which subassemblies 13 don't have any specific additional constituents. Cylindrical and rectangular constituents form together the subassemblies 12 and 13, which further form together the core assembly according to the invention, i.e. the core piece.

The three-phase choke 11 has also coils 14, which, however, are not drawn on top of the outermost vertical assemblies 12 for clarity. By using the cylindrical constituents 1 in the parts that are inside the coils 14 of the choke, the length of the coil 14 can be minimized, because a round shape has a minimal circumference when comparing circumferences of a certain surface area. Rectangular constituents 1 are efficient as the top and bottom parts 13, because then the choke 11 becomes compact in size and shape. Using basic shapes such as rectangular and cylindrical shapes as constituents 1 is usually effective because they are available ready and there is no need to manufacture a specific pressing apparatus for them. The coil 14 can also be placed on top of vertical assemblies i.e. vertical poles, which are made of rectangular constituents 1.

In a simplified form of FIG. 1 the rectangular assembly 13, serving as the top bar of the core, is presented to be disconnected from the cylindrical vertical assemblies 12, i.e. from the vertical poles. In addition, an insulator needed in the choke is not presented in the gap. Respectively, on top of the bottom bar 13 of the choke 11 there is presented an insulator 15, which insulates the horizontal assemblies 13 from the vertical assemblies 12. The terms “horizontal” and “vertical” refer herein only to the example structure according to the Figures. In reality the structure may also be directed also to other directions.

The constituents 1 described above can be joined together using riveting, screwing, bolting, gluing or another known joining method, as well as suitable designing of mechanical tolerances, adjusting the constituents' temperature in such a way that form-lockings and various welding joints can be achieved between the pieces exploiting their thermal expansion. For example, a momentary powerful local electric current can be conducted to the joining point of the constituents, which current heats the joining point momentarily to melting point and thus forms a permanent joint between the constituents when the joining point cools down. When using attachment elements, they can also be added to the coils 14, by which elements the coils attach to the rest of the assembly.

FIGS. 2 and 3 present the simplest constituents 1, which are e.g. the rectangular constituent presented in FIG. 2 and the cylindrical constituent presented in FIG. 3. Each constituent type has at least one counter surface 1a that is adjusted to lean on a corresponding counter surface 1a of another constituent 1, which is placed next to, on top of and/or under the first constituent when manufacturing the subassemblies 12, 13. A rectangular constituent may have not more than six counter surfaces 1a and a cylindrical constituent may have not more than two counter surfaces 1a, which are at the same time the end surfaces of the cylindrical constituent.

FIG. 4 presents a constituent 1 of a magnetic core compressed out of a magnetic powder, which constituent has on its different sides one or more cantilever like fasteners 2 and cavity forming groove fasteners 3 serving as counter surfaces. Cantilever fasteners 2 and groove fasteners 3 are meant to serve as counter surfaces and join with other corresponding structures of essentially similar constituents 1 when joining together constituents 1. Thus the forming core subassembly holds together at least horizontally.

FIG. 5 presents a constituent 1 of a magnetic core compressed out of a magnetic powder, which constituent has also on the same side at least one cantilever like fastener 2 and cavity forming groove fastener 3 serving as counter surfaces. This kind of a structure prevents to a certain extent also the relative vertical movement between the constituents 1 when joining together the constituents 1.

It is efficient to use so-called Sinter-metal material as the core material. It is based on compressed and sintered metal powder. Sinter-metal material can be pressed to a desired form and the forms being manufactured can even be very detailed, in which case e.g. the power electronics, cooling ribs and liquid cooling are easy to integrate to the constituent itself i.e. to the module. Thus the choke/inductive component itself serves as the cooling element. An alternative core material is iron powder, which consists of compressed magnetic powder.

FIG. 6 presents a core assembly 4 achieved by joining together constituents 1 according to the invention, which assembly has constituents 1 whose bottom surfaces are on the same level and a constituent 1 that is situated higher. By joining constituents 1 together in suitable positions, a structure is achieved in which the relative horizontal movement is prevented and in which the constituents 1 can't glide vertically completely freely and overlap each other. This makes the building up of the assembly easier and makes the structure mechanics stronger. For example, the constituents 1 according to FIG. 5 are joined together in such a manner that they set on the same level with each other. Instead, the constituents 1 on the right edge according to FIG. 5 are joined with the constituents 1 in the middle in such a way that they remain half in a diverging level, in which case the result is an upwards growing assembly 4, under which there remains an empty space. When the core is assembled of several constituents 1 the adverse effects of the eddy currents are efficiently reduced.

In FIG. 7 a top plate 5 is placed on top of the assembly. It can be used e.g. to connect additional mechanical constituents or it can remain inside the structure to serve e.g. as an air gap. In FIGS. 7 and 8 the top plate 5 has remained firmly inside the compressed assembly when the assembly was completed. On the side of the assembly there is also a side cleat 6 glided to its place, which cleat attaches to the cantilevers of the constituents 1. Further additional constituents may be attached to the side cleat or the side cleat can be there for esthetical reasons. With the side cleat the structure can also be held together vertically.

FIG. 8 presents that on the other side of the assembly built up of constituents 1 there is a side piece 7 placed in specific indentions. It remained firmly inside the compressed assembly when the assembly was completed and further additional constituents may be attached to it.

FIG. 9 presents a constituent with an attachment part 8, i.e. a fastener attached to it. The fastener touches the cavities of the constituents 1 in a way that gets the different constituents 1 squeezed tightly together. Thus the constituents 1 hold together with each other by claw-like clips, or alternatively the constituents are pressed to each other using a bolt/bolts or some other known method, such as varnishing, gluing, compression or welding.

FIG. 10 presents a hexagonal constituent 1, which also has on its sides cavities 3 and cantilevers 2 serving as indentions and counter surfaces for attachment. This kind of a constituent is efficient because its structure becomes very stable in this way. Correspondingly, FIG. 11 presents an assembly consisting of hexagonal constituents.

FIG. 12 presents a flat hexagonal constituent 1 and a tall hexagonal constituent 9, and a continuous assembly 4 consisting of these two, in which there are hexagonal constituents on top of each other as well as side by side. The Figure illustrates how a desired assembly is achieved horizontally and vertically with flat 1 and tall 9 hexagonal constituents.

FIG. 13 presents a hexagonal constituent 1 that has a cantilever 2 in the same vertical line as a cavity. The purpose of the cantilever 2 is to prevent with its counter surface the free vertical gliding of a corresponding constituent that will be attached next to it.

FIG. 14 presents a constituent 1 that has a hole 10, i.e. an attachment slot. This kind of a hole can be used in joining together constituents and an assembly with bolts, screws, spiral bars, bars or other similar commonly known attachment methods.

In addition, because it is possible to leave little gaps in suitable places between the constituents in the assembly for circulation of air or liquid, it is possible to get the total cooling surface area of a choke consisting of these kinds of constituents significantly larger than that of a corresponding traditional choke, in which case it is possible, respectively, to use higher current density and dissipation power density in the designing phase, which makes the constituent less expensive. Another option to make the cooling more efficient is to use specific cooling modules in the assembly. These can have, for example, liquid cooling, Peltier cooling or phase change cooling. Cooling structures, such as liquid cooling channels can, however, be integrated directly to the constituents. Various cooling structures, such as cooling ribs and liquid cooling channels can be designed to the constituents, for example. Besides or instead of a cooling module, a module added within the constituents can also be a capacitor module or an electronics module, particularly a module containing power electronic connections. These kinds of specific structural modules that have some other function than to form a magnetic core are called non-magnetic constituents. They can be shaped also like magnetic constituents, particularly when considering attachment elements, in which case they form a continuous structure with the magnetic constituents.

FIGS. 15a and 15b present two different ways of manufacturing a magnetic core or an assembly of core constituents. Thus a core assembly 4 is manufactured e.g. by assembling constituents 1, which are compressed out of a powder and consist of insulated particles, into a bundle in such a manner that a naturally formed or specifically manufactured insulator 15 remains between them. Alternatively the core assembly 4 can be manufactured by placing corresponding constituents 1, which are compressed out of a powder and consist of insulated particles, on top of and next to each other or only next to each other in such a manner that a naturally formed or specifically manufactured insulator 15 remains between them. With a method according to the invention the eddy currents can thus be reduced further. Similarly, since the constituents being joined together can be efficiently manufactured directly into the desired shape when compressing them out of a powder, the material dissipation of the process is lower than that of a traditional laminate manufacturing, where a significant part of the material is wasted when manufacturing the laminates.

FIG. 16 presents the main structural constituents of the choke 11 according to the invention. In the three phase version there are three so-called vertical assemblies, i.e. vertical bars 16, which consist of a core and of a coil placed on top of it or a directly winded coil. Furthermore, there are so-called horizontal assemblies, i.e. horizontal bars 17 serving as constituents. In addition, between the vertical bars and horizontal bars there are insulator pieces 18, which have cavities for the vertical bars. The vertical and horizontal bars are manufactured by placing and attaching e.g. by gluing the constituents 1 forming the core assembly inside specific grooves or without the grooves. It is suitable to set air gaps between the constituents 1 particularly in vertical bars, sometimes also in horizontal bars. Thus air gaps are formed also in other places in the structure than at the sites of the insulator pieces, so there are so-called distributed air gaps, which have a number of benefits, such as the magnetic flux bulge towards the coil being smaller than with only a few larger air gaps.

FIG. 17 presents a built-up choke 1, which consists of the above-mentioned constituents 1 and elements.

FIG. 18 presents two views of the choke 11 in its side projection and how to make the structure mechanically strong by making a forming to the grooves 19 that are placed on top of the horizontal bars 17 to protect them. The forming makes it possible to press the vertical and horizontal bars together using fastener rods 20. Similarly, in the Figure on the right one can see that it is suitable to place these fastener rods 20 into the clear area between the coils, in which case the distance between the fastener rods 20 on the opposite sides of the choke 11 is as short as possible.

This kind of a structure makes it possible to disassemble and reassemble the assembly of its elements several times. For example, a tested filter can be disassembled for the transportation and it can be transported disassembled to its possibly difficulty reachable destination where the filter can be assembled quickly. An electric operation center or a wind generator's machine unit are examples of these kinds of targets. Delivered filters may also be updated in the field by replacing only substantially changed parts. For example, a liquid cooling can later be integrated into a horizontal block without liquid cooling. The filters in the field will just need to be replaced with a new horizontal block, if a liquid cooling is desired later on.

FIG. 19 presents alternative liquid cooling implementations. An abovementioned constituent 1 can be replaced with a new core element, a specific liquid cooling element 21, i.e. a liquid cooling constituent, which can most efficiently be fitted e.g. on the surface of or inside the vertical bars, as presented with the black sections in FIG. 19. It is suitable to manufacture these elements 21 of a non-conductive material, such as ceramics or plastic. If they are manufactured out of a metal, such as aluminum, they must have a structure that does not produce high eddy currents. A honeycomb structure is an example of this kind of a structure. Non-conductive materials and honeycomb structural metals can also be combined in a cooling element. In the end corner of the horizontal pole presented up on the right in FIG. 19 it is, however, possible to use a liquid cooling element made of a metal, such as copper or aluminum, because the magnetic flux density is small there.

The winding can also be cooled by placing a liquid cooling heat exchanger 22 in the middle of, on the surface of or inside it. All of these different options are presented in the same FIG. 19. In the vertical bar on the left there is a liquid cooling heat exchanger 22 placed in the middle of the foil-like coil, in the vertical bar in the middle there is a liquid cooling heat exchanger 22 placed on the outer edge of the coil and in the vertical bar on the right there is a liquid cooling heat exchanger 22 placed inside the coil. In FIG. 19 the coils and vertical bars are cross-sectioned but presented without the section lines. The liquid cooling heat exchanger 22 can be e.g. a flat container having an essentially large surface area, made of copper and placed between the foil coils during the winding. Cooling liquid is circulated in the container. Because of the eddy currents the container of the heat exchanger 22 is designed in such a way that is doesn't form a full circle horizontally around the vertical bar of the core to avoid a so-called coil short-circuit.

The abovementioned alternatives can be used alone or mixed with each other.

FIG. 20 presents how it is useful to make grooves 24 to a metallic heat exchanger 23 placed between the core assembly 4 and the coil 14 to prevent eddy currents at the site of the air gaps 25. The idea is to remove metal from the site where there is a field bulge caused by an air gap. This kind of a structure absorbs efficiently heat from the core as well as from the coil. A rule that a radius of a groove is 2 times an air gap may be used as a designing rule.

One option is to use fastener bolts that go into the fastener holes of the core blocks to carry the cooling liquid and to the heat exchange. Metal bolts and rods, which have circulation holes for the cooling liquid in the middle, can be used as the fastener bolts. The fastener rods can also be made of carbon fiber.

Powder metallurgical core or a part of it can also be made so porous that the cooling liquid can flow through it. This kind of a so-called high porosity structure is an efficient heat exchanger.

Capacitors of an LC-filter can also be integrated into the same “package” in such a way that the conductor rails are used as the terminals of the capacitors.

Both of the chokes of an LCL-filter can also be integrated into the same “package” in such a way that they have shared terminals and that they use shared magnetic circuits or mechanical structures when applicable.

The structures can be 3-phased, 1-phased or combinations of these. For example, the filter in FIG. 17 could as well be the main projection of a structure that has three 1-phased chokes.

FIG. 21 presents an efficient method to manufacture a core laminate out of a metallic powder. In the method insulated metal powder or other magnetic powder material 26 is directed between rollers 27 where it is compressed under pressure into laminate 28. Thus it is rolling the powder into solid material.

FIG. 22 presents how a liquid cooling structure can be built into the grooves 19 of the horizontal bars. Then they cool the core efficiently. The Figure presents a side view of a groove 19 and a liquid cooling pipe 29 attached on the surface of it. The liquid cooling pipe 29 can be a separate pipe, which is attached on the side surfaces of the groove 19. Alternatively the liquid flow channels can be made by embedding them on the surfaces of the groove 19 or inside the groove material.

FIG. 23 presents how a liquid cooling channel system 29 is made into the insulator pieces 18 of the choke, viewed from the top.

FIG. 24 presents a method to manufacture a cooling structure for the winding. A formed liquid cooling channel system 29 is placed on top of the foil coil 30, which is in the winding phase and still as an open plate, in such a manner that the ends 31 of the pipe reach outside of the edge of the foil coil 30.

FIG. 25 presents how a cooling structure 22 serving as a liquid cooling heat exchanger forms inside the coil 30, approximately in the middle of the thickness of the coil that is made of foil and ready winded, which cooling structure can be easily connected to the cooling system using the liquid connectors at the ends 31 of the pipe.

Alternatively this kind of a structure could be pushed inside a ready coil. This kind of a cooling structure can be made inside, in the middle of or on the surface of the coil. It can also be made only in one or several of these locations.

Besides the piping, the cooling structure can also consist of connected foils in such a way that a space for the liquid is remained between the foils. Thus a thin and broad structure is achieved.

FIGS. 26-29 present an alternative method to manufacture a coil and a choke. For example, FIG. 26 presents an angular S-shaped piece 32 machined of metal sheet. FIG. 27 presents a conversely symmetrical piece 32 placed on top of the abovementioned piece 32 and in FIG. 28 several these kinds of pieces are placed on top of each other with connections to each other and insulations at suitable positions, thus forming a continuous coil structure 14. A choke is achieved when a core assembly 4 is placed inside a coil 14 according to FIG. 29. It is easy to place liquid cooling elements between the bedded planar layers.

FIG. 30 presents an alternative method 1 to cool either the coil only, several coils, capacitors or the whole choke, or the filter. The piece 33 being cooled, which piece can be the coil only or the whole choke, is placed in a closed liquid cooling container 34, which is filled with heat conductive and electrically non-conductive liquid. For example, deionized water and transformer oil are these kinds of liquids. The heat transferred into the insulator liquid is transferred further into a centralized liquid cooling circulation with a heat exchanger 22 placed inside the container 34. Alternatively the heat exchanger can be placed on the outer wall of the container.

A significant benefit in the cooling and the circulation of the cooling liquid is also the fact that constituents can be suitably left out of the core assembly, in which case suitable channels or gaps are formed to facilitate the air or liquid circulation.

The method according to the invention to manufacture a magnetic core by pressing it out of a powdery material includes at least the following steps: at least a set of essentially identical constituents 1 are compressed out of a powdery raw material. These constituents 1 can be rectangular as presented in FIGS. 1-3, or cylindrical or partly cylindrical. In addition, the constituents 1 can be like the constituents presented in FIGS. 4-15b. In one subassembly, i.e. in a vertical assembly 12 forming a vertical bar or in a horizontal assembly 13 forming a horizontal bar only constituents 1 identical to each other can be used, as presented in FIG. 1. Also constituents 1 different from each other can be used, as presented e.g. in FIG. 12.

Common to all is the fact that at least one counter surface is formed on each constituent 1, which counter surface in a rectangular or cylindrical constituent 1 is the surface 1a, which is placed to lean on another rectangular or cylindrical constituent 1 or a constituent 1 of a suitably different form, when subassemblies i.e. vertical 12 or horizontal 13 assemblies are being assembled of constituents 1 when assembling the core. Counter surfaces can also establish form-locked details, as presented in FIGS. 4-14. These details are various cantilevers 2 and cavities 3. So, when the core is being assembled, at least one counter surface 1a or 2 and 3 of each of the at least two constituents 1 are adjusted to lean on each other. The counter surfaces do not necessarily need to be in a physical contact with each other because there may be e.g. a thin insulator or glue layer between them. Regardless of this layer the counter surfaces 1a or 2 and 3 of both rectangular and cylindrical constituents, and of other constituents, lean on each other i.e. against each other.

The magnetic core according to the invention is a core that is compressed out of a powdery material and is manufactured out of constituents that have at least two dimensions and a third dimension perpendicularly to them, which dimensions limit the size and shape of the constituents. Thus the core consists at least of one component that has one or more constituents 1 compressed out of a powdery material into a certain module size and shape, which constituent has at least one counter surface 1a, 2, 3 for a constituent 1 that is placed on top of, under or next to the first constituent 1. In addition, the abovementioned counter surface 1a, 2, 3 has elements, which prevent the constituent 1 placed on top of, under or next to the constituent 1 from moving at least in one direction. Thus, for example, the rectangular constituent 1 according to FIG. 2 prevents the constituent placed against its counter surface 1a from moving towards it. Similarly, a cylindrical constituent prevents another cylindrical constituent placed on top of it from moving down. In addition, other constituents 1 equipped with various form-lockings prevent corresponding constituents placed on top of, next to or under them from moving thanks to their form-lockings, as described above.

A certain module size herein refers to constituents that form sets of constituents that are compressed into a same size and shape. The size of the constituents is determined e.g. by the pressing capacity of the pressing apparatus. There can be various sizes and shapes. Thus cores can be made even to large chokes or transformers with a small pressing apparatus. The constituents are made in small sizes and in same size for a certain purpose. For example, rectangular constituents are well suitable for horizontal bars and cylindrical constituents are well suitable for vertical bars. Then these small, module sized constituents are assembled together to form big subassemblies. The module size of the constituents thus facilitates both the designing and assembling tasks because it is easy to calculate the final required size by means of the module size.

A coil 14 is placed around the vertical bars 12 of the core assemblies assembled according to the abovementioned method, which coil 14 is ready-winded elsewhere or it is winded on the spot. Thus the coil 14 is not necessarily placed on top of the whole core assembly but only on top of a subassembly i.e. on top of the vertical bars 12. Thus the coil 14 is placed on top of at least one subassembly 12 of the core.

It is easy to design and construct chokes and transformers with the solution according to the invention. A set of various constituents 1 is made with a pressing apparatus, which constituents are dimensioned to an ideal module size for the designing, properties and the pressing capacity of the pressing apparatus. Subassemblies i.e. vertical and horizontal bars of the core are made ready according to the desired choke/transformer properties by joining a required amount of constituents together by gluing or other joining method. This part of the manufacturing task can be made at any suitable place. After this the subassemblies are assembled to form the ready cores and the chokes/transformers are finished by adding the required coils and other components into connection with the cores. The final assembly can be made at any suitable place by delivering the subassemblies and the other required components to the final assembling place. It is easy and quick to assemble the final assembly out of the ready subassemblies and it is also easy to automate the process.

To those skilled in the art it is clear that the invention is not exclusively limited to the examples specified above, but can be varied within the scope of the patent claims listed below. Thus, for example, the constituents can be shaped like halves or e.g. quarters of cylinders instead of whole cylinders. Out of these it is easy to assemble a cylindrical vertical assembly, when needed, to form a vertical bar of the core.

1. A method to manufacture a magnetic core piece out of a powdery material by pressing, characterized in that at least the following steps are performed to manufacture the core:
at least a set of essentially identical constituents (1) is pressed out of a powdery raw material;
at least one counter surface (1a, 2, 3) is formed on each constituent (1);
when the core is being assembled, at least one counter surfaces (1a, 2, 3) of each of the at least two constituents (1) are adjusted to lean on each other;
a coil (14) is winded around at least one core assembly (12) assembled in this manner.

2. The method according to claim 1, characterized in that at least a part of the constituents (1) is manufactured by pressing the constituents (1) essentially into a shape of a rectangle, onto which constituents (1) at least one counter surface (1a) is formed.

3. The method according to claim 1, characterized in that at least a part of the constituents (1) is manufactured by pressing the constituents (1) essentially into a shape of a cylinder and at least one end surface of the constituents (1) is formed into a counter surface (1a).

4. The method according to claim 1, characterized in that at least a part of the constituents (1) is manufactured by pressing in such a way that the constituents (1) are equipped essentially with at least one form-lockable counter surface (2, 3).

5. The method according to any of the claims above, characterized in that attachment elements are formed onto the constituents (1), by which attachment elements the constituents (1) are locked with each other horizontally and/or vertically.

6. The method according to claim 1, characterized in that attachment holes (10) are formed onto the constituents (1).

7. A magnetic core piece manufactured by pressing it out of a powdery material, which core is manufactured out of components that have at least two dimensions and a third dimension perpendicularly to them, which dimensions limit the size and shape of the components, characterized in that:
the core consists at least of one component that has one or more constituents (1) compressed out of a powdery material into a certain module size and shape
each constituent (1) has at least one counter surface (1a, 2, 3) for a constituent (1) that is placed on top of, under or next to the first constituent (1)
the said counter surface (1a, 2, 3) has elements, which prevent the constituent (1) placed on top of, under or next to the constituent (1) from moving at least in one direction.

8. The magnetic core piece according to claim 7, characterized in that at least a part of the constituents (1) is manufactured by pressing the constituents (1) essentially into a shape of a rectangle, which constituents (1) have at least one counter surface (1a).

9. The magnetic core piece according to claim 7, characterized in that at least a part of the constituents (1) is manufactured by pressing the constituents (1) essentially into a shape of a cylinder, which constituents (1) have at least one counter surface (1a).

10. The magnetic core piece according to any of claims 7-9 above, characterized in that at least a part of the constituents (1) is equipped with at least one form-lockable counter surface (2, 3) that affects in one direction.

11. The magnetic core piece according to any of claims 7-9 above, characterized in that at least a part of the constituents (1) is equipped with two form-lockable counter surfaces (2, 3) that affect in two different directions.

12. The magnetic core piece according claim 7 above, characterized in that at least a part of the constituents (1) is equipped with at least one attachment hole (10).
